(19) United States
(12) Patent Application Publication
(10) Pub. No.: US 2014/0189888 A1
(43) Pub. Date: Jul. 3, 2014

(54) SECURE DATA CONTAINER FOR AN AMBIENT INTELLIGENT ENVIRONMENT

(71) Applicant: CLOUDCAR, INC., Los Altos, CA (US)

(72) Inventors: Ajay Madhok, Los Altos, CA (US); Evan Malahy, Santa Clara, CA (US); Ron Morris, Seattle, WA (US)

(73) Assignee: CLOUDCAR, INC., Los Altos, CA (US)

(21) Appl. No.: 13/730,929

(22) Filed: Dec. 29, 2012

(51) Int. Cl. H04L 29/06

(52) U.S. Cl. CPC H04L 63/08
USPC 726/29

(57) ABSTRACT

A system and method for providing a secure data container for an ambient intelligent environment are disclosed. A particular embodiment includes: collecting a set of information from a first digital network information endpoint associated with a vehicle; associating, by use of a data processor, a persistent digital identifier with the collected information, the persistent digital identifier being derived from information associated with the vehicle; enabling a user to specify a shared data set from the collected information; enabling the user to specify a set of sharing controls corresponding to the shared data set; combining information identifying the shared data set and the sharing controls in a secure container; and enabling to second digital network information endpoint to access the shared data set via the secure container upon presentation of a valid secure access token.

### COPYRIGHT NOTICE

A portion of the disclosure of this patent document contains material that is subject to copyright protection. The copyright owner has no objection to the facsimile reproduction b anyone of the patent document or the patent disclosure, as it appears in the U.S. Patent and Trademark Office patent Ides or records, but otherwise reserves all copyright rights whatsoever. The following notice applies to the disclosure herein and to the drawings that form a part of this document: Copyright 2010-2012, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to an ambient intelligent environment supported by a cloud-based vehicle information and control system.

### BACKGROUND

An increasing number of vehicles are being equipped with one or more independent computer and electronic processing systems. Certain of the processing systems are provided lot vehicle operation or efficiency. For example, many vehicles are now equipped with computer systems for controlling engine parameters, brake systems, tire pressure and other vehicle operating characteristics. A diagnostic system may also be provided that collects and stores information regarding the performance of the vehicle's engine, transmission, fuel system and other components. The diagnostic system can typically be connected to an external computer to download or monitor the diagnostic information to rid a mechanic during servicing of the vehicle.

Additionally, other processing systems may be provided for vehicle driver or passenger comfort and/or convenience. For example, vehicles commonly include navigation and global positioning systems and services, which provide travel direction and emergency roadside assistance. Vehicles are also provided with multimedia entertainment systems that include sound systems, e.g., satellite radio, broadcast radio, compact disk and MP3 players and video players. Still further, vehicles may include cabin climate control, electronic scat and mirror repositioning and other operator comfort features.

However, each of the above processing systems is independent, non-integrated and incompatible. That is, such processing systems provide their own sensors, input and output devices. power supply connections and processing logic. Moreover, such processing systems may include sophisticated and expensive processing components, such as application specific integrated circuit (ASIC) chips or other proprietary hardware and/or software logic that are incompatible with other processing systems in the vehicle or the surrounding environment.

Additionally, consumers use their smart phones for many things (there is an app for that). They want to stay connected and bring their digital. worlds along when they are driving a vehicle. They expect consistent experiences as they drive. But, smartphones and vehicles are two different worlds. While the smartphone enables their voice and data to roam with them, their connected life experiences and application (app)/service relationships do not travel with them in a vehicle.

Consider a vehicle as an environment that has ambient intelligence by virtue of its sensory intelligence, IVI (in-vehicle infotainment) systems, and other in-vehicle computing or communication devices. The temporal context of this ambient intelligent environment of the vehicle changes dynamically (e.g., the vehicle's speed, location, what is around the vehicle, weather, etc. changes dynamically) and the driver may want to interact in this ambient intelligent environment with mobile apps and/or cloud based services. However, conventional systems are unable to react and adapt to these dynamically changing environment.

Vehicle users consume navigation and several other in-vehicle services, such as communication and music. These users have relationships outside the vehicle with people, places, and things (e.g., apps and services). Users would like to be always connected with these relationships when the users are in the vehicle or on the move. Today, users have a very limited ability to use these relationships for the exchange of data and messages with these people, places, and things outside the vehicle, in a manner that is easily accessible and vehicle-safe.

Likewise, users have relationships with some others by virtue of owning a vehicle. These relationships include people, places, and things that users visit or have to work with for routine tasks, such as fueling up the vehicle, getting n serviced, its maintenance and repair, its registration, insurance and meeting regulatory compliances like emission checks. Users also have relationships with their vehicle dealer and others involved with the sale, in-life purchases (like options), and resale of the vehicle. The data, information, and messages that are exchanged between with these end points are mostly done in the physical world. Consequently the users do not have whenever and wherever access to their vehicle data, much less a transportable digital identity.

### SUMMARY

A system and method for providing a secure data container for an ambient intelligent environment is described herein in various example embodiments. An example embodiment reifies the vehicle as a digital identity in its own right and provides mechanisms to unify vehicle related data and associated relationships in a linked data cloud in a manner that is secure (e.g., encrypted) and gives the user the provenance over this unified data. In an example embodiment, a linked data cloud is a data network for exposing, sharing, and connecting items of data, information, and knowledge on the semantic Web using conventional data linking technologies. In other words, the example embodiments enable unified vehicle and driver data to be linked to the vehicle via the cloud. For example, the unified data can include: status attributes of the vehicle, such as its make, model, year, vehicle identification number (VIN), etc.; usage data, such as mileage, fuel level, oil level, etc.; real-time performance data, such as speed, location, traffic, torque, fuel efficiency, bumps jumped over/pothole encountered, etc.; vehicle service and repair data, including warranties and part replacements; vehicle insurance data; vehicle regulatory compliance data, such as registration, smog check, tickets, etc.; driver(s) data, such as identities and information of all who drive the vehicle, routes, destinations, preferences, etc.; the driver(s) qualitative driving data, such as average speed, hard use of brakes, use of signals, violations, etc. It will be apparent to those of ordinary skill in the art that a variety of other data of vehicle and/or the driver(s) can be captured and retained in the unified data and linked to a vehicle. Further, the example embodiment enables the user/driver(s) to link their profile, their calendar, social graph/contacts, and other data from their mobile applications (apps) and cloud services to create custom, personalized datasets of their digital identity and share them with user-configured controls.

In an example embodiment, this unified data set is normalized, homogenized, semanticized, aggregated, encrypted, and stored in association with a persistent digital identity. Entities and relationships in a vehicle data graph get cross-linked and cross-referenced. The vehicle data graph can be annotated, queried, and used as a knowledge endpoint. The various embodiments enable a user to share a subset of the processed unified data with others while retaining and asserting sharing controls, such as access, privacy, expiry, synchronization and usage.

This sharing is enabled by means of a vehicle-based Distributed Shared Data Object that represents a secure data container with bi-directional links to shared data providing a fail-safe mechanism to enforce the controls on the shared data.

The vehicle-based Distributed Shared Data Objects of an example embodiment can be personalized using templates and shared under user control. A vehicle-based Distributed Shared Data Object template can be shared under user-control, at-will or automatically, based on user defined/configured triggers with a dynamically determined set of receivers. The triggers/receivers encapsulate or identify information including:
1. What information is sent (e.g., estimated time of arrival (ETA), or a “running low cm fuel” indication, vehicle service records, and/or the like);
2. Who/what is the receiver (e.g., a user, a cloud service, a service provider, and/or the like, along with related authentication credentials);
3. How is the information sent (e.g., data transmission, network cloud transmission, application programming interface (API) access, service oriented architecture (SoA) request, message, text, email, dashboard indicator, and/or the like;
4. When is the information sent (e.g., on occurrence of an event, when the vehicle passes a checkpoint, when the vehicle is stopped, periodically, and/or the like; and
5. Data Sharing Controls to provide user-configurable control over what is shared, such as Access (who can access it), Privacy (can it be shared with others by the receiving party), Synchronization (what is shared gets synchronized with new versions of data as it changes at source), Usage (how can the shared data be used), and Expiry (how long is the shared in formation available).

In other words, the vehicle-based Distributed Shared Data Object and its related service of an example embodiment act like “banker for vehicle data”—a trusted third party that helps vehicle drivers sham their vehicle related and other data in the same way banks help exchange funds or e-mail providers help exchange e-mail and files. The various example embodiments also include the ability to link and nest multi-sourced information To provide context; full addressability of all the shared data in manner that authorization and control enforcement can be built into the vehicle-based Distributed Shared Data Object.

In various typical scenarios enabled by the various embodiments described herein, the vehicle-based Distributed Shared Data Object can be shared with a variety of different types of recipients of the data. Three example types of shared data recipients are described below.

1. Other People (Friends, Family, Colleagues . . . , Someone in the Social Graph of the User/Driver)

As described in more detail below, a user/driver/vehicle occupant (sender) may send a vehicle-based Distributed Shared Data Object to other people (recipients) to share with them a sender's expected time of arrival (ETA) and real-time location including their route so that the recipients can see on a map where the sender is located at a given point of time; and how they are progressing towards their destination. The ETA can be automatically updated based on the driver's real-time location, traffic data, distance left, real speed clocked, time of the day, etc. Additionally, a sender may share their current location on a map (that shows their dynamic or real-time location) and send pictures from their current location (e.g., a scenic route—a picture taken with their vehicle's front camera, or a point of interest (POI) enroute, etc.). Users may also post their vehicle-based Distributed Shared Data Object on post channels like Facebook and Twitter and share their location, or the music they are listening to, their fuel efficiency or any subset of the unified vehicle/driver data that is associated with their vehicle.

2. Service Providers

A user may select a subset of their unified vehicle/driver data and use a vehicle-based Distributed Shared Data Object to send the data subset to a service provider, such as a repair shop. The vehicle-based Distributed Shared Data Object can include the service records and the health records of the vehicle, as this data is captured as part of the unified data associated with the vehicle. Additionally, the service provider can be an insurance company covering the vehicle and the vehicle drivers (the insured) with insurance coverage. The insured can send the insurance company a vehicle-based Distributed Shared Data Object with quantitative and qualitative data, such as vehicle mileage, routes, destinations, time of the clay usage, speed, excessive speed incidents, violation incidents, such as incomplete stops at a STOP sign, making illegal U-turns, not signalling while changing lanes, late entries into exits, distracted driving incidents, such as abnormal steering deviations, sudden speed changes not correlated to traffic, tail-gating (or coming too close) the vehicle ahead, etc. This shared data can enable the insurance company to rate the driver and offer Pay as you Drive (usage-based insurance) or Pay How You Drive (PHYD) Insurance. A Vehicle-based Distributed Shared Data Object can also be sent to a service provider, such as the Department of Motor Vehicles (DMV) with emissions data of the vehicle to perform a virtual smog check. A user may also send a vehicle-based Distributed Shared Data Object to the DMV to get their vehicle registration renewed, etc.

3. Vehicle Dealer and Original Equipment Manufacturer (OEM)

A user can configure an embodiment to automatically send a vehicle-based Distributed Shared Data Object to their vehicle dealer and OEM whenever the vehicle detects an abnormality with the operation or status of the vehicle. For example, the standard subsystems of the vehicle may detect a Low ABS (Anti-Look Braking System) Traction condition. On the occurrence of this condition, the vehicle with one of the embodiments described herein can automatically send a vehicle-based Distributed Shared Data Object to the vehicle dealer and/or OEM with information related to the anomaly detection. In this manner, the vehicle-based Distributed Shared Data Object of an example embodiment can be used to send problem reports and diagnostics data back to the vehicle dealer and/or OEM so the problem/condition can be reported in real-time and analyzed individually or as a whole (aggregated problem/issue data across all cars of a certain model, make, year, etc.).

In all cases, the user maintains provenance over the shared data and the user can configure and assert controls on the data being shared via a set of data sharing controls. The data sharing controls can include: Access, Privacy, Synchronization, Usage, and Expiry controls.

Access controls enable the sharing user to control who gets to access or see what is shared. The various embodiments ensure that the access is secure and the recipient is authenticated so the shared data can only be accessed by the intended recipient.

The data sharing controls can include Privacy controls. Privacy controls enable the sharing user to allow the recipient to control who can view the shared data—the recipient only, or their mutual friends, or any interested parties as determined by the recipient under control of the sharing user. The Privacy controls can also be used to specify whether the recipient can make the data public. The Privacy controls can also be used to enable the recipient to forward the shared data, or the sharing user can choose to make the shared data only for the eyes of the recipient and the shared data cannot be shared by the recipient, and no one else can view the Shared data. In this case, even if the recipient forwards the Distributed Shared Data Object to a friend or someone else, that party to who the Distributed Shared Data Object was forwarded cannot de-reference and access the data.

The data sharing controls can include Synchronization controls enabling the recipient to get a copy of the latest data as it changes in real-time. This means that the user does not have to keep pushing versioned or updated data to the recipient—the synchronization data controls detect when the source data changes and push a new copy. The vehicle-based Distributed Shared Data Object system of an example embodiment implements a push and poll data mechanism to keep the information that is shared synchronized and up-to-date. For example, if the user shares their location and ETA with another user, the ETA and current location (on a map) is updated as the user is driving.

The data sharing controls can include Usage controls. The Usage controls ensure that the shared data is used by the recipients only in the manner specified by the sharing user. The Usage controls enable the sharing user to specify the types of usages of the shared data that are authorized by the sharing user. For example, a user's qualitative driving data can be configured via the usage controls for sharing only to get a PHYD insurance quote from the insurance provider and not to report the user's qualitative driving data to authorities.

The data sharing controls can include Expiry controls. The Expiry controls ensure that the data shared by use of a vehicle-based Distributed Shared Data Object expires at the user-controlled time. After expiration, the recipient does not get to access or see the shared data.

All the data sharing controls are enforced by having a push and pull link between the container (the Distributed Shared Data Object) and the linked data cloud of the vehicle. These embodiments are explained in more detail below.

As described in more detail below, a user can configure a vehicle-based Distributed Shared Data Object to automatically collect their vehicle/driver shared data, or the user can submit the vehicle data manually (through a form submission to a web service), or to receive their vehicle/driver shared data by subscribing to and configuring known data sources. Users can create, edit or choose a Presentation template (e.g., choose a theme, color, font, etc.) from a library of vehicle-based Distributed Shared Data Object profiles, such as templates for sharing ETA information for business, sharing ETA information with friends and family, sharing current location with current music selections; sharing vehicle service records, sharing driver rating information, etc. Users can also customize templates in terms of what dataset to share and the look and feel (e.g., the style or theme of the data presentation) and store the configured templates in their library. Users can also set triggers to auto-share specific vehicle-based Distributed Shared Data Objects based on specified conditions and dynamically picked information and recipient. For example, in an example embodiment, a Trigger÷Action rule can be configured that will perform the following actions in response to the following conditions: when the user leaves for home, send a vehicle-based Distributed Shared Data Object to a family member (as previously specified), wherein the vehicle-based Distributed Shared Data Object specifies the ETA and the current location of the user. Another example would be sharing ETA with other users who are at the destination to which the user is headed, as inferred by an upcoming meeting event in the user's calendar and matching the vehicle's destination to the location of the meeting. Various embodiments can also enable the user to set fine-grained sharing rules for a particular vehicle-based Distributed Shared Data Object. The sharing rules can be specialized on a per attribute and per relationship basis (e.g., share the song I am listening to with my friends, but not with my business colleague). In addition, in a particular embodiment, vehicle-based Distributed Shared Data Objects can be shared in run-time using voice commands. For example, the user can speak a command: Send ETA to John. In response to the voice command, a particular embodiment can send a vehicle-based Distributed Shared Data Object to John, where John is the person on the calendar that the user is headed to meet.

In an example embodiment as described in more detail below, the vehicle-based Distributed Shared Data Object system is a cloud based service that provides at least three basic services: data unification, data sharing, and enforcement of controls. The data unification service is a data pipeline architecture that considers at least three types of data sources: 1) data sources that are structured, such as vehicle data, for which a data adapter exists; 2) sources which are unstructured/manual (form based data submission); and 3) data sources that do not have a data adapter, but provide a pull mechanism/subscription mechanism (e.g., a location feed). The data unification service of an example embodiment receives multi-sourced data, normalizes the received data, semanticizes the data using a vehicle ontology and/or other known ontologies, such as Friend of a Friend (FOAF) as relevant, and homogenizes the data so that the data can be unified as a linked graph. The data is encrypted and stored. The data sharing service of an example embodiment enables a user to configure a vehicle-based Distributed Shared Data Object and specify data sharing rules. At run-time, when a vehicle-based Distributed Shared Data Object is shared, the recipient receives a secure access token as an encrypted link. When the recipient de-references the secure access token (e.g., the user clicks on the link), an embodiment presents the secure access token to the vehicle-based Distributed Shared Data Object delivery gateway (e.g., a content delivery network), which authenticates that the user who is presenting the secure access token is indeed the user to whom the secure access token was sent, authorizes the data to be shared with the recipient (e.g., looks up the data sharing policy referenced by the secure access token), and redirects the user (silently) to the vehicle-based Distributed Shared Data Object. The shared data can be served in the context of a web browser or a social network service like Facebook or the shared data can be viewed, on a mobile device via a browser. The various embodiments enforce sharing controls via the vehicle-based Distributed Shared Data Object, which is a secure container that maintains a push and pull link with the content delivery network to enable the pushing of data updates to the vehicle-based Distributed Shared Data Object. In one embodiment, this push mechanism is implemented using AJAX.

In summary, the various example embodiments provide a system and method of aggregating and unifying a vehicle's data and user data with to persistent digital identity and enriching the data with the user profile and configurable parameters of the user. Further, the various example embodiments enable mechanisms to share a subset of this unified data under user-configured control. The user-configured controls go beyond access control and include privacy, expiry, usage, and synchronization controls.

The various example embodiments described herein provide a system to unify the various data, identifiers, apps, and services, both in-vehicle and outside-the-vehicle. This unified data is linked to the user and the vehicle's digital identity so that the data can be accessed by the user anytime, anywhere, on any device, and shared with others (under user control) in their larger social and vehicle related ecosystem. Further, the various example embodiments enable sharing of the data automatically and autonomously based on certain triggers (e.g., such as the user is likely to be late in arriving at a destination, or the user crossed a geo fence, or is running low on gas, etc.).

The vehicle-based Distributed Shared Data Object comprises the key services described in more detail below.

### BRIEF DESCRIPTION OF THE DRAWINGS

The various embodiments is illustrated by way of example, and not by of limitation, in the figures of the accompanying drawings in which:

FIG. 1 illustrates an example embodiment of the components of the system providing a secure data contain for an ambient intelligent environment;

FIG. 2 is a system diagram illustrating an example embodiment of a system and method for providing a secure data container for an ambient intelligent environment as described herein;

FIG. 3 is a processing flow diagram illustrating an example embodiment of a system and method for providing a secure data container for an ambient intelligent environment as described herein;

FIG. 4 illustrates a representative sample of the types of information retained in the collection of information stored in the network cloud for a particular endpoint;

FIG. 5 illustrates an example of a secure container in an example embodiment;

FIG. 6 illustrates an example of a secure container in an example embodiment;

FIG. 7 illustrates an example of the collection of information corresponding to a vehicle along with the associated persistent digital identity being uploaded from the computing platform of the vehicle to components of the vehicle-based Distributed Shared Data Object system 110 operating in the network cloud in an example embodiment:

FIG. 8 illustrates the processing performed by the Data Unification Service of an example embodiment;

FIG. 9 illustrates the processing performed by the Data Sharif Service of an example embodiment;

FIG. 10 illustrates the processing performed by the Vehicle-based Distributed Shared Data Object Service Module of an example embodiment;

FIG. 11 illustrates the processing performed by the Data Access/Sharing Control Enforcement Service Module of an example embodiment;

FIG. 12 is a processing flow chart illustrating an example embodiment of a system and method for providing a secure data container for an ambient intelligent environment; and

FIG. 13 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

As described in various example embodiments, a system and method for providing a secure data container for an ambient intelligent environment are described herein. In one particular embodiment, a system and method for providing a secure data container for an ambient intelligent environment is provided in the context of a cloud-based vehicle information and control ecosystem configured and used as a computing environment with access to a wide area network, such as the Internet. However, it will be apparent to those of ordinary skill in the art that the system and method for providing as secure data container for an ambient intelligent environment as described and claimed herein can be implemented, configured, and used in a variety of other applications and systems.

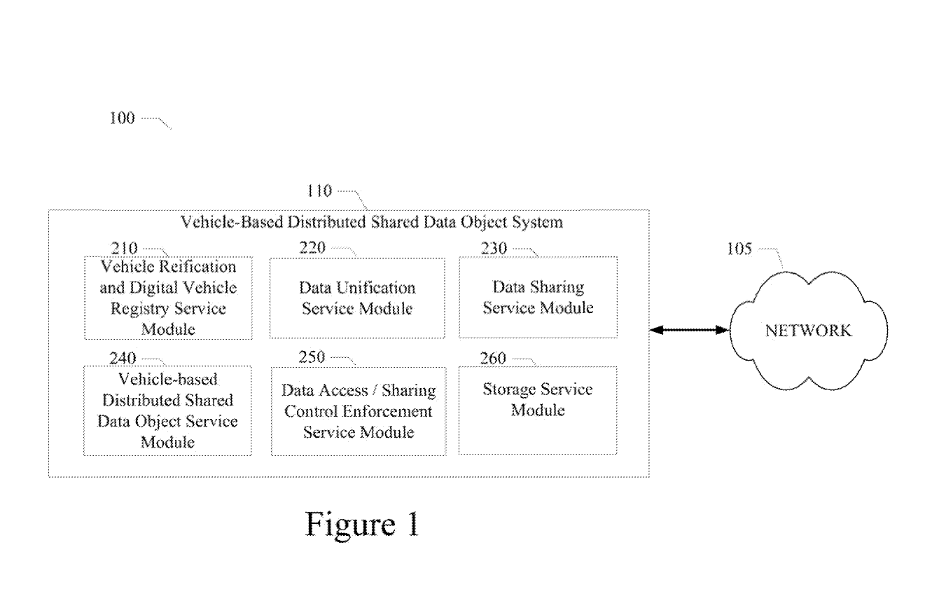

Referring now to FIG. 1, the vehicle-based Distributed Shared Data Object system 110 of an example embodiment is shown to include a Vehicle Reification and Digital Vehicle Registry Service module 210, a Data unification Service module 220, a Data Sharing Service module 230, a Data Access/Sharing Control Enforcement Service module 240, a Storage Service module 250, and a Vehicle-based Distributed Shared Data Object Service module 260. Each of these modules or components can be implemented as software components executing within an executable environment 100 of the vehicle-based Distributed Shared Data Object system 110. These modules can also be implemented in whole or in part as network cloud components, remote service modules, service-oriented architecture components, mobile application (app) executable components, hardware components, or the like for processing signals and data for the vehicle-based Distributed Shared Data Object system 110. In one example embodiment, one or more of the service modules of the vehicle-based Distributed Shared Data Object system 110 are executed in whole or in part on a computing platform in a vehicle. One or more of the service modules of the vehicle-based Distributed Shared Data Object system 110 can also be executed in whole or in part on a computing platform (e.g., a server or peer-to-peer node) in the network cloud 105. In another example embodiment, one or more of the service modules of the vehicle-based Distributed Shared Data Object system 110 are executed in whole or in part on a computing platform of a mobile device, such as a mobile telephone (e.g., iPhone™, Android™ phone, etc.) or a mobile app executing therein. Each of these service modules of an example embodiment is described in more detail below in connection with the figures provided herein.

In an example embodiment the vehicle-based Distributed Shared Data Object system 110 and its related services comprise the key services described below and illustrated in FIG. 1.

### Vehicle Reification and Digital Vehicle Registry Service

The Vehicle Reification and Digital Vehicle Registry Service, implemented by the Vehicle Reification and Digital Vehicle Registry Service Module 210 of an example embodiment, associates a persistent digital identifier with a vehicle (or other digital network information resource or endpoint) to create a digital network resource that can be identified and uniquely addressed. The identifier enables data and services to be associated with the digital network information resource (e.g., the vehicle). In one embodiment, the Vehicle Reification and Digital Vehicle Registry Service uses the VIN (vehicle identification number) number of the vehicle as the persistent, non-repudiable identifier to create a new abstract and persistent digital identifier(s) for the vehicle in the network cloud. The persistent digital identifier can be derived from a unique set of information related to a particular digital network information resource or endpoint, such as a vehicle. These persistent digital identifiers are designed so that they are both human friendly and machine friendly. As such, these persistent digital identifiers can be used across all contexts. All of the static attributes of the vehicle, such as the make, model year color, brand, VIN, etc, as well as the vehicle's dynamic attributes, such as mileage, speed, location, destination, rating, emissions, resale value, registration, insurance data, and the like can be associated with the persistent digital identifier of the vehicle. Likewise, the driver(s) data, such as a particular driver's preferences (e.g., mirror position, seat position, music selections, etc.), driver profile, the driver's usage data (e.g., routes, places, violations, ratings, usage of services in car, etc.), and the like can be linked with the persistent digital identifier of the vehicle and thus the vehicle-based digital identity. All of the data associated with a persistent digital identifier is stored behind a privacy barrier in a secure and encrypted manner. Thus, a secure data container with an associated persistent digital identifier for an ambient intelligent environment can be created.

The Vehicle Reification and Digital Vehicle Registry Service of an example embodiment provides all of the services required to reify vehicles as digital endpoints and the services required to register the digital endpoints with the digital vehicle registry in the network cloud. The registration of the digital endpoints and an associated secure data container enables users (e.g., drivers, dealers, resellers, and the like), mobile apps, and services to access, update and share data sets of the secure data container linked to the digital endpoints under the explicit control of the user and/or the original equipment manufacturer (OEM), depending on who has provenance over what data.

### Data Unification Service

The Data Unification Service, implemented by the Data Unification Service Module 220 of an example embodiment, aggregates and homogenizes a user's preferences, profile, usage, data, relationships, calendar, mobile apps, and cloud services consumed by the user (e.g., service identifiers or handles) and links this data to the user's or vehicle's persistent digital identity as created or obtained by the Vehicle Reification and Digital Vehicle Registry Service described above. The Data Unification Service also links the vehicle's real-time data, such as speed, mileage, vehicle sensory and intelligence data, the vehicle's service, repairs and maintenance data to the vehicle's persistent digital identity and makes the linked data available, under user control, with other data owned by the user. As described in more detail below, the Data Unification Service semanticizes the multi-sourced, ontologically diverse data in the dataset using a particular ontology that provides the concepts related to the user resources, the vehicle resources, and their usage in terms of entities and relationships and the network of semantic concepts, their properties, and behaviors to enable contextual exchange of data between user resources, vehicle resources, cloud resources, with the resources of other users, mobile apps, and other services. The Data Unification Service maintains the linked data associated with the vehicle resources and its user(s) resources and provides mechanisms to address and identify specific components of data. The Data Unification Service of an example embodiment can generate a unified database with an ontology of the user, the vehicle, and related resources in terms of entities and relationships and a network of semantic concepts, their properties, and behaviors. The database can act as a knowledge end point that can be queried by and exchange messages with other services.

The various example embodiments described herein provide a system to unify the various data, identifiers, apps, and services, both in-vehicle and outside-the-vehicle. This unified data is linked to the user and the vehicle's persistent digital identity so that the data can be accessed by the user anytime, anywhere, on any device, and shared with others (under user control) in their larger social and vehicle related ecosystem. Further, the various example embodiments enable sharing of the data automatically and autonomously based on certain triggers (e.g., such as the user is likely to be late in arriving at a destination, or the user crossed a geo fence, or is running low on gas, etc.).

### Data Sharing Service

A Data Sharing Service, implemented by the Data Sharing Service Module 230 of an example embodiment, enables the user to select a subset of their unified data and to share the selected data subset with others under user control. The ability of the user to share the selected data is enabled by the vehicle-based Distributed Shared. Data Object described herein. For example, the shared data subset could be the data related to the vehicle's current location, the music to which the vehicle occupants are listening, and where the vehicle is currently heading (e.g., pre-defined vehicle destination). This data subset can be shared with their friends, an auto dealer, employer, advertiser, or any other entity or endpoint of the user's choosing. Alternatively, the shared data set could include the vehicle's expected time of arrival (ETA) and the average speed the vehicle is travelling. For example, this data can be shared with a person the vehicle occupants are driving to visit. To simplify data sharing, the system provides a library of Distributed Shared Data Object profiles that have pre-defined data sets. The user can create new profiles, edit, and customize existing profiles.

Apart from enabling the user to select data attributes or data subsets and share the dataset with others, the Data Sharing Service of an example embodiment provides two other capabilities: 1) presentation personalization; and 2) sharing with control. Presentation personalization relates to selecting a template that will be used to present the data the user has selected for sharing. Given that the template is also described as data, the template is also treated at par with the user's other data. The sharing with control capability enables the user to provide, specify, or configure the controls that are applied to the selected data the user wants to share. In one embodiment, these controls include: 1) access control (e.g., with whom does the user want to share the dataset and/or who can access the shared dataset); 2) privacy control (e.g., is the shared dataset only for the eyes of the specified entity or can the specified entity forward the shared dataset to someone else, like a mutual friend); 3) synchronization control (e.g., controls for updating shared data if the data changes); 4) Expiry Control (e.g., controls that specify the period of time for which the data can be shared); and 5) Usage Control (e.g., controls to specify the purpose for which the data can be used). The Data Sharing Service of an example embodiment essentially enables the user to specify and modify the various controls for various types of datasets. The Data Sharing Service also enables the user to customize the specified controls for an individual user, as group of users, a type of user, a service, or the like. As described in more detail below, the data is essentially shared with others using a secure token that needs to be de-referenced to obtain access to the shared data. The enforcement of the controls is performed by another service of the vehicle-based Distributed Shared Data Object system 110 that is described below.

### Data Access/Sharing Control Enforcement Service

The Data Access/Sharing Control Enforcement Service, implemented by the Data Access/Sharing Control Enforcement Service Module 250 of an example embodiment, enforces the sharing controls described above by acting as a secure content delivery network for the two way links associated with the vehicle-based Distributed Shared Data Object. In other words, the vehicle-based Distributed Shared Data Object represents a secure data container that can only be opened by the intended person, service, and/or endpoint for which the secure data container was configured by the user. The secure data container maintains a push and pull link with the cloud-based Data Access service that uses the two way mechanism to enforce controls. If the vehicle-based Distributed Shared Data Object secure access token is authenticated and authorized, the secure access token redirects the data requests corning from the vehicle-based Distributed Shared Data Object container to a Content Delivery Network/Storage Service that is described below. The Data Access/Sharing Control Enforcement Service records all the data sharing transactions for enabling audits.

### Storage Service

The Storage Service, implemented by the Storage Service Module 260 of an example embodiment, encrypts and stores the linked dataset for the vehicle and its user(s) in the network cloud and acts like a Content Delivery Network. The Storage Service acts in concert with the Data Access Service to provide ready-to-be-consumed data securely to the endpoint that presents a valid vehicle-based Distributed Shared Data Object.

### Vehicle-based Distributed Shared Data Object Service

The Vehicle-based Distributed Shared Data Object Service, implemented by the Vehicle-based Distributed Shared Data Object Service Module 240 of an example embodiment, is a generalized, extensible service for unifying ontologically diverse, multi-sourced data for the vehicle and its user(s), homogenizing the data, and making the data available for sharing under control of the user wherever and whenever the user chooses, The Vehicle-based Distributed Shared Data Object Service provides a standardized and portable authorization mechanism for sharing the secure data container (e.g., represented by the vehicle-based Distributed Shared Data Object) with user-configured controls. The Vehicle-based Distributed Shared Data Object Service enforces control over the authority (provenance), security, privacy, and rights of shared data expressed in a standard machine-readable format by the vehicle-based Distributed Shared Data Object. The vehicle-based Distributed Shared Data Object is a human and machine-readable document that governs the sharing of particular user-specified vehicle and user datasets. Unlike a conventional Web link, which is essentially a one-dimensional ‘string’ that ‘pulls’ a linked document into as browser, a vehicle-based Distributed Shared Data Object is a graph of metadata (typically in JavaScript Object Notation—JSON or Extensible Markup Language—XML) that can actively control the flow of data from a publisher (e.g., the Data Access/Sharing Control Enforcement Service and the Storage Service) to a subscriber (e.g., the user, service, and/or endpoint to which the vehicle-based Distributed Shared Data Object is sent) by either as ‘push’ or ‘pull’ data transfer mechanism. The data flow is controlled by the terms of the user-configured controls, which can be highly flexible and extensible. For example, in several example embodiments, the vehicle-based Distributed Shared Data Objects can govern a variety of common data sharing scenarios. Several example data sharing scenarios are presented next.

A vehicle-based Distributed Shared Data Object can be used for sharing vehicle location and ETA data with a friend, sharing vehicle performance data with a rating service, sharing vehicle service and repair data with a service provider, sharing driver rating and violations data with parents or insurance providers, sharing, vehicle usage, service and collision data with a reseller, etc.

The vehicle-based Distributed Shared Data Objects can be a key element of digital trust frameworks enabled by connected cars ranging from enabling simple For Your Information (FYI) exchanges to commercial applications, such as Pay How You Drive Insurance to business-to-government services, such as smog, checks.

As an example, the user may explicitly choose to send a vehicle-based Distributed Shared Data Object with their ETA to a contact or configure a service to implicitly/automatically send a vehicle-based Distributed Shared Data Object to a contact based on the calendar and destination information. But, depending on to whom the vehicle-based Distributed Shared Data Object is being sent (e.g., friend, family, business colleague, etc.) and depending on the context of the user (e.g., on a business trip, vacation, location, time/date, status, etc.), the vehicle-based Distributed Shared Data Object can be configured to send different datasets depending on the recipient and the context at the moment the data is ready to be sent. For example, as part of the dataset shared by the vehicle-based Distributed Shared Data Object, some people may only get the ETA information, some others may get the ETA information plus the current location of the vehicle, while some others may get the ETA information plus the current location of the vehicle plus information indicative of the current song being played in the vehicle, etc. This means that the same vehicle-based Distributed Shared Data Object when de-referenced by different people resolves to a different data set. The vehicle-based Distributed Shared Data Object becomes an expression of sharing with control. This means there is a privacy barrier between the user and the vehicle's aggregated profile and what is visible to the person de-referencing the vehicle-based Distributed Shared Data Object at a particular time.

In another scenario, a user can send a vehicle-based Distributed Shared Data Object to a repair/maintenance workshop. When the repair/maintenance workshop dereferences the vehicle-based Distributed Shared Data Object, the repair/maintenance workshop may get access to the appropriate health records, maintenance data, and/or service data of the vehicle that the user has chosen to share with the repair shop. As a result, the vehicle-based Distributed Shared Data Object represents a secure access token that can be shared under the provenance and control of the user with other parties in their ecosystem. The vehicle-based Distributed Shared Data Object of an example embodiment provides the user with mechanisms to control not only the access of the appropriate data by the appropriate recipients, but also provides other data controls, such as privacy (e.g., is the shared data for the recipient's eyes only), expiry (e.g., is the shared data for one view, or will the shared data persist for one hour, one day, or will the shared data persist for a longer period). The vehicle-based Distributed Shared Data Object of an example embodiment also provides other controls including synchronization to take into account that the shared data can change dynamically. For example, the ETA information shared might, change based on live traffic conditions as the user is driving to the destination. Once the vehicle-based Distributed Shared Data Object is shared, the synchronization control remains active and auto-updates the ETA and distance/location information.

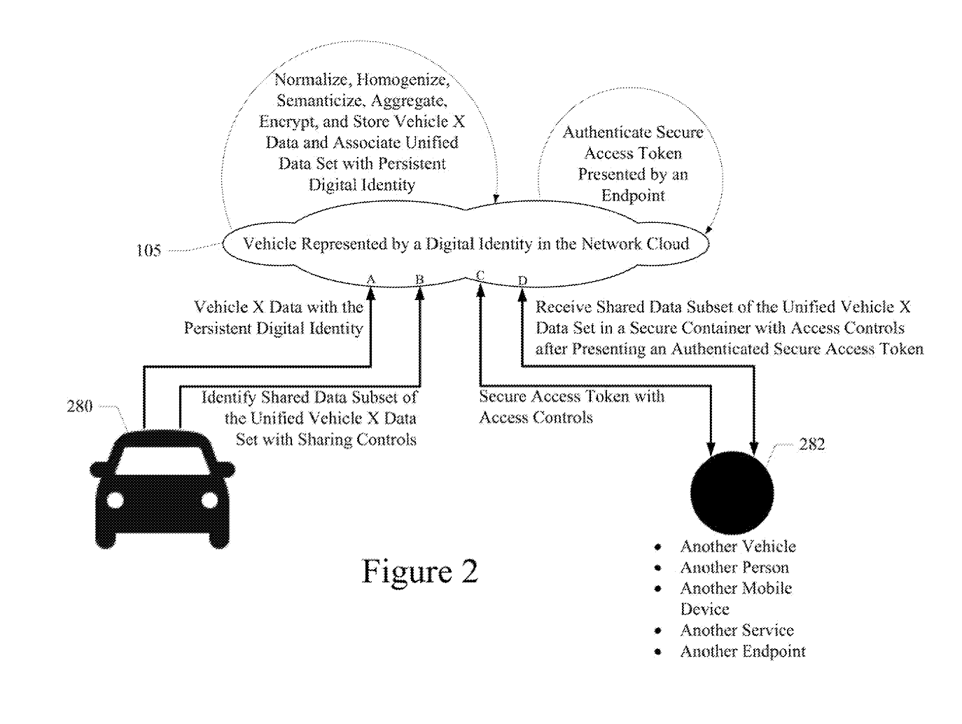

Referring now to FIG. 2, a system diagram illustrates an example embodiment of a system and method for providing a secure data container for an ambient intelligent environment as described herein. The vehicle-based Distributed Shared Data Object system 110 of an example embodiment can be implemented in part on a computing platform of vehicle 280. Other portions of the vehicle-based Distributed Shared Data Object system 110 of an example embodiment can be implemented in part on a computing platform (e.g., a server or as peer-to-peer node) in the network cloud 105. In another example embodiment, the vehicle-based Distributed Shared Data Object system 110 of an example embodiment can be implemented in part on a computing platform of a mobile device, such as a mobile telephone (e.g., iPhone™, Android™ phone, etc.) or a mobile app executing therein. The mobile device executing portions of the vehicle-based Distributed Shared Data Object system 110 can be located proximately to the vehicle 280 or coupled to a computing subsystem of the vehicle 280. The vehicle 280 or the mobile device therein represents the originator or source of data to be shared using the vehicle-based Distributed Shared Data Object system 110 of an example embodiment.

Similarly, corresponding portions of the vehicle-based Distributed Shared Data Object system 110 of an example embodiment can be implemented in part on a computing platform of an endpoint 282. Endpoint 282 represents a computing platform of another person, another vehicle, another mobile device, another service, or other type of computing endpoint. In another example embodiment, corresponding portions of the vehicle-based Distributed Shared Data Object system 110 of an example embodiment can be implemented in part on a computing platform of a mobile device, such as a mobile telephone (e.g., iPhone™, Android™ phone, etc.) or a mobile app executing therein. The mobile device executing portions of the vehicle-based Distributed Shared Data Object system 110 can be located proximately to the endpoint 282, coupled to a computing subsystem of the endpoint 282, or the mobile device itself may represent the endpoint 282. The endpoint 282 or the mobile device therein represents the consumer or the recipient of data to be shared by others using the vehicle-based Distributed Shared Data Object system 110 of art example embodiment. In general, the sample system diagram shown in FIG. 2 represents the vehicle 280 as an originator or source of data to be shared. The endpoint 282 represents the consumer or the recipient of the data shared by the originator 280 via the network cloud 105 and the vehicle-based Distributed Shared Data Object system 110.

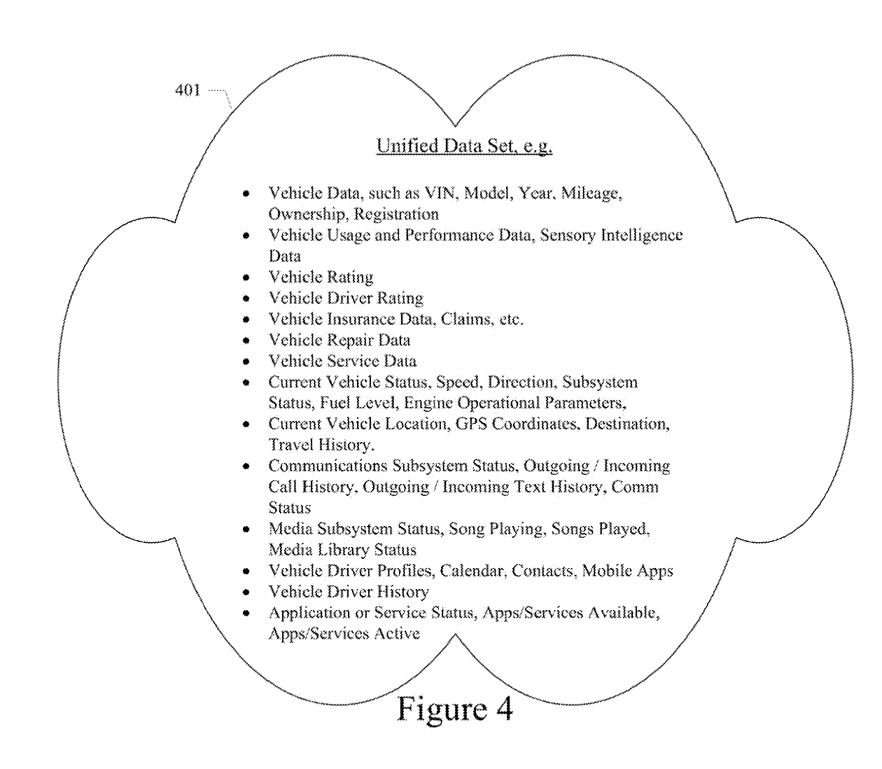

Referring still to FIG. 2, a user associated with vehicle 280 (identified as Vehicle X in this example), can choose to have the vehicle-based Distributed Shared Data Object system 110 of an example embodiment build a unified data set in the network cloud 105. The components of the vehicle-based Distributed Shared Data Object system 110 operating in the cloud 105 (e.g., a computing platform, such as a server or a peer-to-peer node in data communication via network 105 with the components of the vehicle-based Distributed Shared Data Object system 110 operating on the computing platform of the vehicle 280) can receive a request from the user associated with vehicle 280 to build the unified data set. As part of this request, the vehicle-based Distributed Shared Data Object system 110 can assemble a collection of information pertaining to the vehicle 280 and one or more people associated with the vehicle 280. This collection of information can include the static attributes of the vehicle, such as the make, model year, color, brand, VIN, etc. as well as the vehicle's dynamic attributes, such as mileage, speed, location, destination, routing, rating, emissions, resale value, registration, insurance data, and the like. Likewise, the driver(s) data, such as a particular driver's preferences (e.g., mirror position, seat position, music selections, etc.), driver profile, the driver's usage data (e.g., routes, places, violations, ratings, usage of services in car, etc.), and the like can be collected. Other driver or occupant information can be collected, such as online personas (e.g., login names and passwords for social network accounts, such as Facebook™), email addresses and passwords, mobile device numbers and access information, Twitter™ handles, favorite website login information, and a variety of other information connecting the people associated with the vehicle 280 with various social communities or online presence. Additionally, the collection of information can include links to a user profile, calendar, social graph/contacts, data from mobile applications (apps) and/or cloud services, and other personalized datasets. A representative sample of the types of information in the collection of information is shown in FIG. 4. It will be apparent to those of ordinary skill in the art that a wide variety of information associated with vehicle 280 and its associated people can be collected as part of the assembled collection of information.

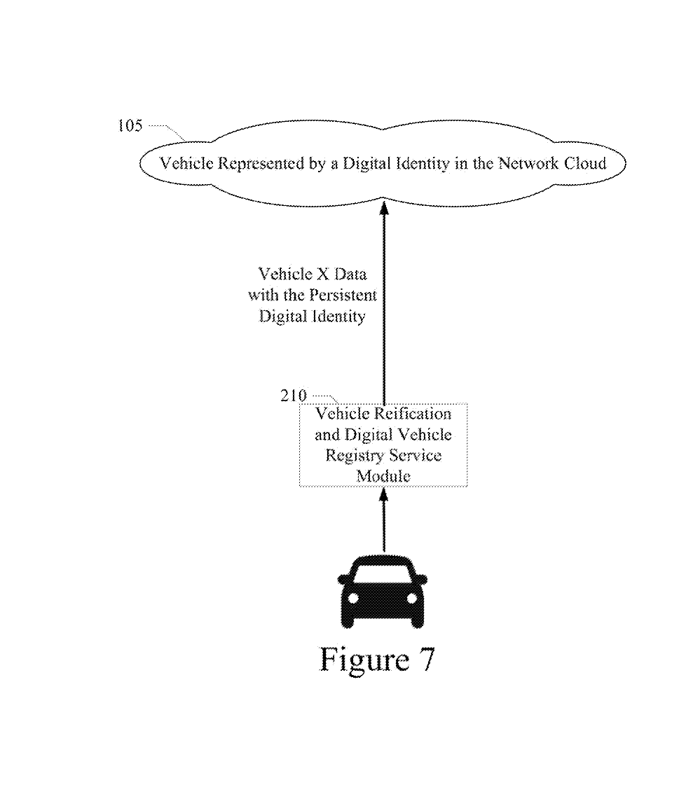

The vehicle-based Distributed Shared Data Object system 110 of an example embodiment can link the assembled collection of information with a persistent digital identity. The persistent digital identity, generated by the Vehicle Reification and Digital Vehicle Registry Service, associates an identifier with the vehicle 280 to create a digital network resource that can be identified and uniquely addressed. In one embodiment, the Vehicle Reification and Digital Vehicle Registry Service uses the VIN (vehicle identification number) number of the vehicle 280 as the persistent digital identity. In another embodiment, the VIN number can be concatenated (or otherwise combined with) with a user name/identifier, a time/date stamp, a location identifier, a random number, or other information to generate a unique persistent digital identity. This persistent digital identity can be linked to, associated with, combined with, or used to index the assembled collection of information corresponding to the vehicle 280 from which the persistent digital identity was derived. As shown in FIG. 2 and FIG. 7, the collection of information corresponding to the vehicle 280 along with the associated persistent digital identity can be uploaded from the computing platform of the vehicle 280 to components of the vehicle-based Distributed Shared Data Object system 110 operating in the cloud 105. The vehicle-based Distributed Shared Data Object system 110 of an example embodiment provides all of the services required to reify vehicles as digital endpoints and provides the services required to register the digital endpoints with the digital vehicle registry in the network cloud 105. These registration services are described in more detail below.

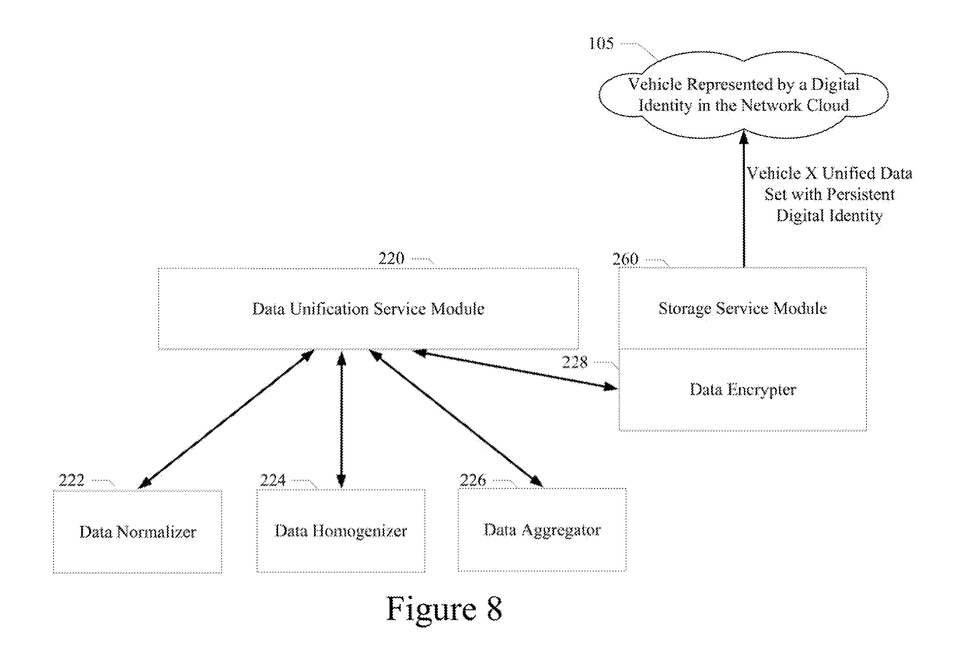

When the vehicle-based Distributed Shared Data Object system 110 receives the collection of information and the associated persistent digital identity, the Data Unification Service of an example embodiment operates on the received data to create and register a unified data set associated with the persistent digital identity of the corresponding vehicle 280. FIG. 8 illustrates the processing performed by the Data Unification Service of an example embodiment. As shown in FIG. 8, the Data Unification Service uses a data normalizer 222 to represent the data in a manner that is independent of the underlying schema of the data as originally presented. As part of this normalization, the data normalizer 222 can convert particular data items in the Vehicle X collection of information to a standard or common representation. This standard or common representation can be used for a plurality of collections of information from a plurality of vehicles. As a result, the information from one vehicle is more easily correlated with information from a different vehicle. For example, the vehicle's real-time data, such as speed, mileage, and fuel level can be converted to a common form in common units of measure. The static attributes of the vehicle, such as the make, model year, color, brand, VIN, etc. can also be converted to standard representations. The normalization of the data in the Vehicle X collection of information facilitates efficient storage and search of data items in the collection of information.

As also shown in FIG. 8, the Data Unification Service uses a data homogenizer 224 to process particular data items in the Vehicle X collection of information to semanticize the data. Semanticizing the data includes associating a concept with the particular data items. For example, a data item in the Vehicle X collection of information that identifies a particular vehicle model can be semanticized to associate the data item with as corresponding vehicle classification, such as sport utility vehicle, economy car, hybrid, or truck. Similarly, other concepts, tags, categories, or classifications can be associated with particular data items or groupings of data items from the Vehicle X collection of information. Further, the concepts associated with data in the Vehicle X collection of information can be arranged in a hierarchical ontology that can form links or associations between different data items at different abstraction layers. As a result, the data homogenizer 224 can expand the scope and breadth of the information associated with the Vehicle X collection of information. Additionally, as part of this homogenization of the data, the data homogenizer 224 can also remove or modify data items that are likely errant or out-dated. Correlations can be drawn between a variety of data items to identity a particular data item that is likely incorrect. For example, a VIN number may not correlate to the make and model of the vehicle identified in the same collection of information. The data homogenizer 224 can reconcile these inconsistencies and correct the collection of information.

As also shown in FIG. 8, the Data Unification Service uses a data aggregator 226 to further process the Vehicle X collection of information. The data aggregator 226 can join the data in the Vehicle X collection of information as a linked graph. The data aggregator 226 can thereby form mathematical structures to model pairwise or n-wise relations between data objects from the Vehicle X collection of information. Additionally, the data aggregator 226 can link data objects from the Vehicle X collection of information with data objects from other vehicle information collections or information collections from other endpoints. As a result, the data aggregator 226 can weave together data connections and correlations among data collections from a variety of endpoints. Thus, the Data Unification Service semanticizes the multi-sourced, ontologically diverse data using a particular ontology that provides the concepts related to the vehicle and its usage in terms of entities and relationships and the network of semantic concepts, their properties, and behaviors to enable contextual exchange of data with users, mobile apps and other services. Additionally, the data aggregator 226 can establish data connections with a plurality of data sources to establish one or more data streams from multiple data sources. For example, the data aggregator 226 can use the data received from vehicle 280 to establish and register data connections to one or more data sources from the vehicle 280. These data sources can originate from vehicle computing platforms, mobile device computing platforms, or data sources in the network cloud 105. These data connections enable the vehicle-based Distributed Shared Data Object system 110 to capture real-time data from these data sources on an on-going basis. For example, these data connections enable the vehicle-based Distributed Shared Data Object system 110 to update the Vehicle X collection of information on a periodic basis. The data connections also enable the vehicle-based Distributed Shared Data Object system 110 to obtain current data when another endpoint makes an authorized request for access to a portion of the Vehicle X collection of information. The ability to obtain current data in real time enables a synchronization control (e.g., controls for obtaining shared data if the data changes). Thus, the vehicle-based Distributed Shared Data Object system 110 can unify the various data, identifiers, apps, and services, both in-vehicle and outside-the-vehicle from a plurality of vehicles or other endpoints. This unified data is linked to the user and the vehicle's persistent digital identity so that the data can be accessed by the user anytime, anywhere, on any device, and shared with others (under user control) in their larger social and vehicle related ecosystem.

As also shown in FIG. 8, the Data Unification Service or the Storage Service can use data encrypter 228 to further process the Vehicle X collection of information. The data encrypter 228 can encrypt the Vehicle X collection of information and associate a decryption key with the persistent digital identity. In one embodiment, the Storage Service can also perform as data compression operation on the Vehicle X collection of information. As a result of the various processing operations performed by the Data Unification Service and the Storage Service as described above, the Vehicle X collection of information is transformed into an encrypted unified data set with a corresponding persistent digital identity that uniquely and securely links or hinds the unified data set with the endpoint from which the data originated (vehicle 280 in the example shown in FIG. 2). The vehicle-based Distributed Shared Data Object system 110 in the network cloud 105 maintains full control over the access and modification of this unified data set. In a similar manner, the vehicle-based Distributed Shared Data Object system 110 can collect unified data sets from a plurality of endpoints, such as vehicle 280. All of these unified data sets can be stored in the network cloud 105.

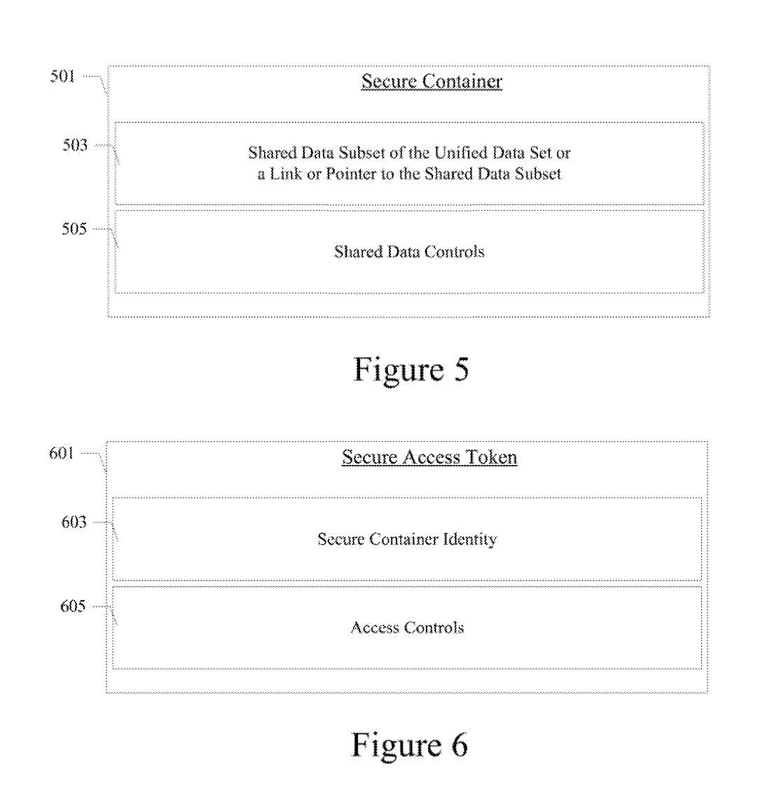

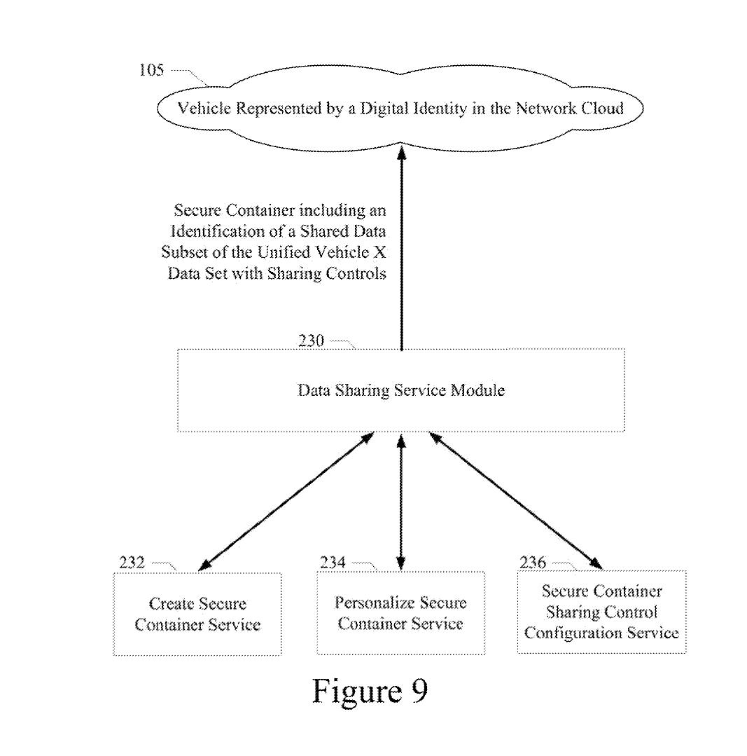

Referring again to FIG. 2 and to FIG. 9, the user associated with vehicle 280 has caused a unified data set associated with vehicle 280 to be created and stored in the network cloud 105 as described above. Once the unified data set is created and stored, the user can identify portions of the unified data set that the user authorizes for sharing, with others, such as endpoint 282 shown in FIG. 2. The Data Sharing Service, implemented by the Data Sharing Service Module 230 of an example embodiment shown in FIG. 9, enables the user to select a subset of their unified data set and share the selected data subset with others under user control. The Data Sharing Service can use a conventional log-in process to validate the credentials of a user seeking to access or manipulate a particular unified data set. Once the user successfully logs into the Data Sharing Service, the user can obtain access to a Create Secure Container Service 232 of an example embodiment. Using the Create Secure Container Service 232 shown in FIG. 9, the user can identify the selected subset in a variety of ways. In one embodiment, individual data items from the unified data set can be identified by a user via a user interface. In another embodiment, groupings of related data items, such as vehicle service data, navigation data, driver profile, and the like can be identified by a user via a user interface. In another embodiment, one of a variety of templates can be used to select the subset of data. Using any of these methods, the user can specify the data to be shared. The specification of the shared data is retained in a secure container. The secure container is a data structure that retains information that identifies the shared data and retains control information that defines the access rights over the shared data approved by the user. An example of a secure container 501 in an example embodiment is shown in FIG. 5. As illustrated in FIG. 5, the secure data container 501 includes information 503 that identifies the shared data and shared data control information 505 that defines the access rights over the shared data. En one embodiment, the secure container can retain the shared data itself in another embodiment, the secure container can include a link(s), a pointer(s), a path definition(s), or other means for identifying a source of the shared data. Once the secure container is created, the secure container can be personalized and sharing controls can be defined as described below.

As shown in FIG. 9, the Data Sharing Service of an example embodiment provides a Personalize Secure Container Service 234 for specifying the manner in which the shared data represented by the secure container is presented to a consuming or receiving endpoint. The presentation personalization features provided by the Personalize Secure Container Service 234 enables the user to create, select, and/or modify a template that will be used to present the subset of data the user has selected for sharing. Given that the template is also described as data, the template is also treated at par with the user's other data. The presentation personalization feature of the Personalize Secure Container Service 234 enables the user to customize the manner in which the shared data is viewed by those who request access to the shared data.

As also shown in FIG. 9, the Data Sharing Service of an example embodiment provides a Secure Container Sharing Control Configuration Service 234 for specifying how and with whom the shared data can be shared. The sharing control configuration capability enables the user to provide, specify, or configure the controls that are applied to the selected data the user wants to share. In one embodiment, these controls include: 1) access control (e.g., with whom does the user want to share the dataset and/or who can access the shared dataset); 2) privacy control (e.g., is the. shared dataset only for the eyes of the specified entity or can the specified entity forward the shared dataset to someone else, like a mutual friend); 3) synchronization control (e.g., controls for updating shared data if the data changes); 4) Expiry Control (e.g., controls that specify the period of time for which the data can be shared); and 5) Usage Control (e.g., controls to specify the purpose for which the data can be used). The Data Sharing Service of an example embodiment essentially enables the user to specify and modify the various controls for enabling, access to the shared portions of the unified data set. The Data Sharing Service also enables the user to customize the specified controls for an individual user, a group of users, a type of user, or a service. Once the user specifies the sharing controls as described above, the corresponding secure container is updated to reflect the user's sharing control selections. As shown in FIG. 9, the secure container, including an identification of the shared data and the corresponding sharing controls can then be uploaded to the network cloud 105 and associated with the persistent digital identity corresponding to the unified data set from which the shared data originated. As described in more detail below, the data identified by the secure container can be essentially shared with others as a secure token that needs to be dc-referenced to get access to the shared data. The enforcement of the controls is performed by the Vehicle-based Distributed Shared Data Object Service Module 240 and the Data Access/Sharing Control Enforcement Service Module 250 as described below.

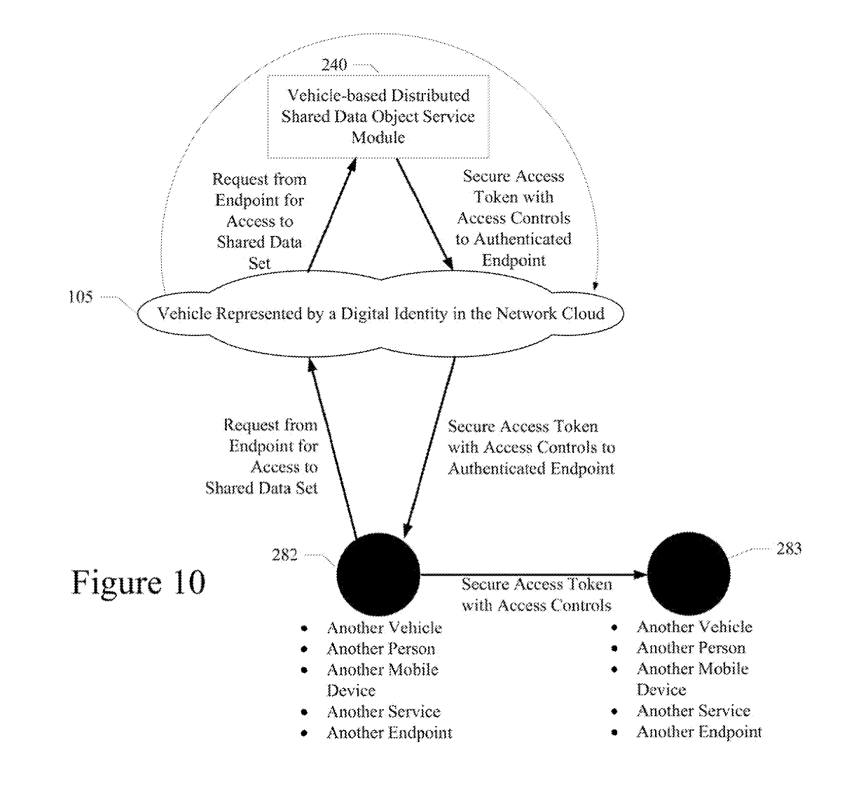

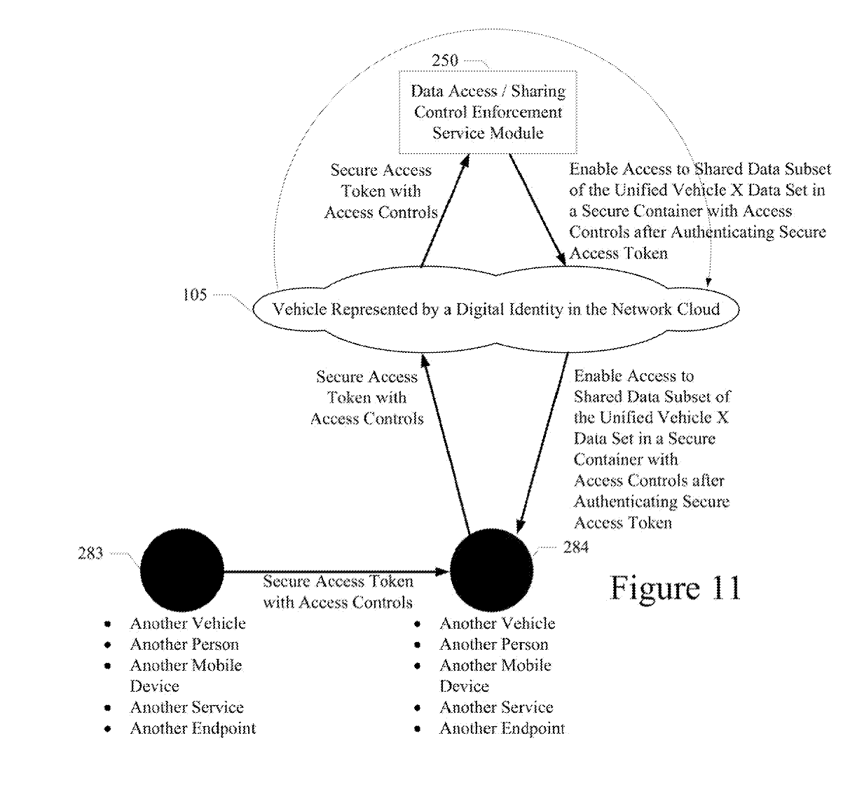

Referring now to FIGS. 10 and 11, the Vehicle-based Distributed Shared Data Object Service Module 240 and the Data Access/Sharing Control Enforcement Service Module 250 of an example embodiment are illustrated. The Vehicle-based Distributed Shared Data Object Service Module 240 and the Data Access/Sharing Control Enforcement Service Module 250 are responsible for enforcing the sharing controls specified by the user as described above. As also described above, the user has established a unified data set with a corresponding persistent digital identity in the network cloud 105. The user has also identified a shared data set of the unified data set and specified a corresponding set of sharing controls. The identification of the shared data and the corresponding sharing controls are retained in a secure container with the corresponding persistent digital identity in the network cloud 105. At this point, the vehicle-based Distributed Shared Data Object system 110 in the network cloud 105 can receive a request from an endpoint 282 for access to the shared data originated by the vehicle 280 or a user associated therewith. This request is shown in FIG. 10.

Referring now to FIG. 10, the Vehicle-based Distributed Shared Data Object Service Module 240 has received a request via network cloud 105 front endpoint 282 for access to a shared data set of the unified data set of vehicle 280 and its associated user(s). The Vehicle-based Distributed Shared Data Object Service Module 240 can identify the requesting endpoint 282 and validate the request against the sharing controls established for the shared data set by the originating user associated with vehicle 280. If the Vehicle-based Distributed Shared Data Object Service Module 240 can validate the requesting endpoint 282, the Vehicle-based Distributed Shared Data Object Service Module 240 can generate a secure access token, which can be used by the requesting endpoint 282 to obtain access to the shared data set of vehicle 280 and its associated user(s) via an associated secure container. The secure access token is a data structure that retains information that identities the associated secure container and retains access control information that defines the access rights over the associated secure container and thus the access rights to the shared data approved by the originating user. An example of a secure access token 601 in an example embodiment is shown in FIG. 6. As illustrated in FIG. 6, the secure access token 601 includes information 603 that identities the associated secure container and access control information 605 that defines the access rights over the associated secure container. Referring again to FIG. 10, once the Vehicle-based Distributed Shared Data Object Service Module 240 validates the requesting endpoint 282. the Vehicle-based Distributed Shared Data Object Service Module 240 can transmit a secure access token to the requesting endpoint 282 via network 105. The secure access token can be retained by the endpoint 282 and used to access the shared data as shown in FIG. 11 and described below. Additionally, the endpoint 282 can transmit the secure access token to another endpoint (e.g., endpoint 283 shown in FIG. 10). Assuming the endpoint 283 conforms to the shared access controls established by the originating user, the endpoint 283 can also use the secure access token to access the shared data as shown in FIG. 11 and described below.

Referring now to FIG. 11, the endpoint 283 is shown transferring its secure access token to another endpoint 284. For the examples illustrated in FIGS. 10 and 11, the secure access token received by endpoint 284 is given to be a secure access token corresponding to a secure container associated with the shared data set of vehicle 280 shown in FIG. 2 and described above. Referring again to FIG. 11, the endpoint 284 can present this secure access token to the Data Access/Sharing Control Enforcement Service Module 250 of an example embodiment via network cloud 105. The Data Access/Sharing Control Enforcement Service Module 250 can identify the presenting endpoint 284 and validate the secure access token against the access controls established for the corresponding secure container and the sharing controls established for the shared data set by the originating user associated with vehicle 280. If the Data Access/Sharing Control Enforcement Service Module 250 can validate the presenting endpoint 284 based on the presented secure access token. the Data Access/Sharing Control Enforcement Service Module 250 can enable the endpoint 284 to obtain access to the shared data set of vehicle 280 and its associated user(s) via an associated secure container. Once the secure access token has been validated for the endpoint 284, the Data Access/Sharing Control Enforcement Service Module 250 can act as a secure content delivery network for the two way links associated with the secure container represented by a corresponding vehicle-based Distributed Shared Data Object. In other words, the vehicle-based Distributed Shared Data Object represents a secure data container associated with the validated secure access token, wherein the secure container can only be opened by the intended person, service, and/or endpoint for which the secure data container was configured or authorized by the originating user. The secure data container maintains a push and pull link with the cloud-based the Data Access/Sharing Control Enforcement Service Module 250 that uses the two way mechanism to enforce the sharing and access controls. If the corresponding secure access token is authenticated and authorized as shown in FIG. 11, the secure access token redirects the data requests coming from the corresponding secure container to the Storage Service Module 260 described above where the shared data can be accessed by the authenticated and authorized endpoint (such as endpoint 284 shown in the example off FIG. 11). In another embodiment, the Data Access/Sharing Control Enforcement Service Module 250 and/or the Storage Service Module 260 can automatically trigger the pushing of shared data to authorized endpoints on a one-time or periodic basis in response to previously configured triggers. These triggers can be activated based on the occurrence of an event or the detection of a condition in the vehicle related ecosystem. For example, triggers can be configured, such as whether the user is likely to be late in arriving at a destination, whether the user/vehicle crossed a gen fence, whether the vehicle is running low on gas, etc.) In this manner, an authorized endpoint can retain updated information from the shared data set. Additionally, the Data Access/Sharing Control Enforcement Service Module 250 can record all the data sharing transactions for enabling audits.

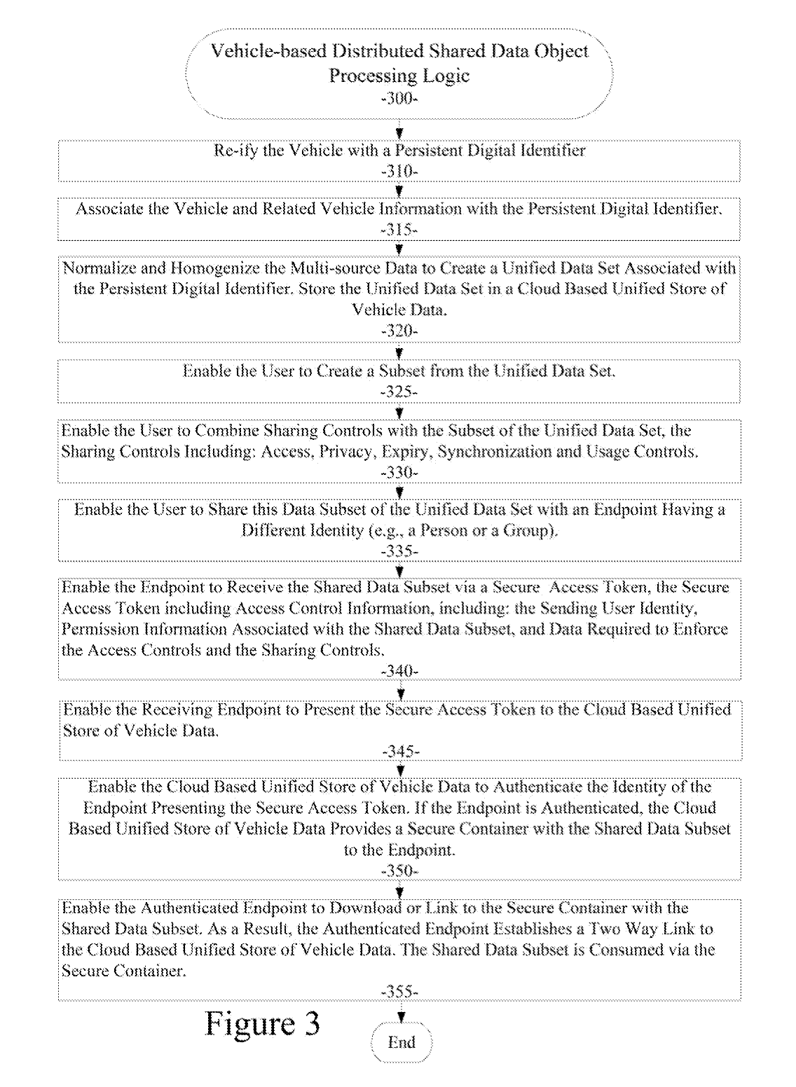

Referring now to FIG. 3, a processing flow diagram illustrates an example embodiment of a system and method for providing a secure data container for an ambient intelligent environment as described herein. The method 300 of an example embodiment includes the elements described above, which are configured to: reify the vehicle with a persistent digital identifier (processing block 310); associate the vehicle and related vehicle information with the persistent digital identifier (processing block 315); normalize and homogenize the multi-source data to create a unified data set associated with the persistent digital identifier and store the unified data set in a cloud based unified store of vehicle data (processing block 320); enable the user to create a subset from the unified data set (processing block 325); enable the user to combine sharing controls with the subset of the unified data set, the sharing controls including; access, privacy, expiry, synchronization and usage controls (processing block 330); enable the user to share this data subset of the unified data set with an endpoint having a different identity (e.g., a person or a group) (processing block 335); enable the endpoint to receive the shared data subset via a secure access token, the secure access token including access control information, including: the sending user identity, permission information associated with the shared data subset, and data required to enforce the access controls and the sharing controls (processing block 340); enable the receiving endpoint to present the secure access token to the cloud based unified store of vehicle data (processing block 345); enable the cloud based unified store of vehicle data to authenticate the identity of the endpoint presenting the secure access token; if the endpoint is authenticated, the cloud based unified store of vehicle data provides as secure container with the shared data subset to the endpoint (processing block 350); enable the authenticated endpoint to download or link to the secure container with the shared data subset; and as a result, the authenticated endpoint establishes a two way link to the cloud based unified store of vehicle data and the shared data subset is consumed via the secure container (processing block 355).

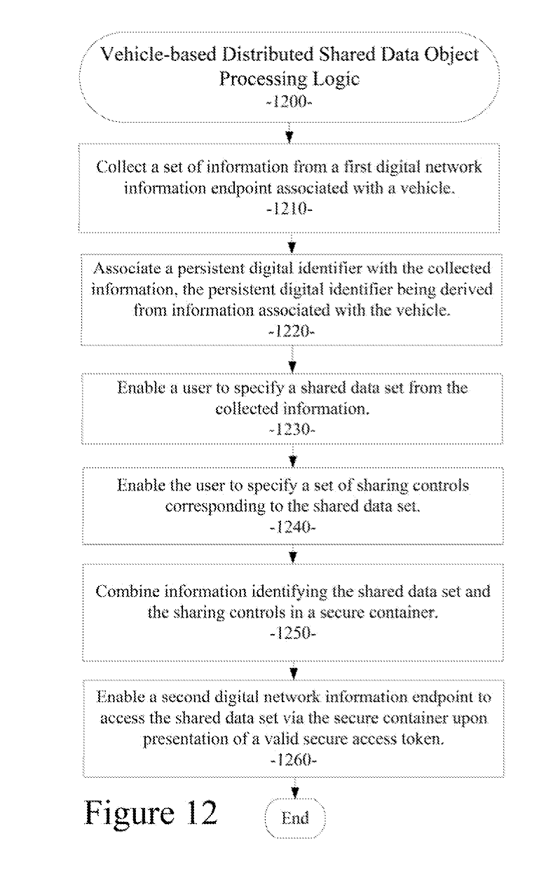

FIG. 12 is a processing flow diagram illustrating an example embodiment of a system and method for providing a secure data container for an ambient intelligent environment as described herein. The method 1200 of an example embodiment includes: A system and method for providing a secure data container for an ambient intelligent environment. are disclosed. A particular embodiment includes: collecting a set of information from a first digital network information endpoint associated with a vehicle (processing block 1210); associating, by use of as data processor, a persistent digital identifier with the collected information, the persistent digital identifier being derived from information associated with the vehicle (processing block 1220); enabling a user to specify a shared data set from the collected information (processing block 1230); enabling the user to specify a set of sharing controls corresponding to the shared data set (processing block 1240); combining information identifying the shared data set and the sharing controls in a secure container (processing block 1250); and enabling a second digital network information endpoint to access the shared data set via the secure container upon presentation of a valid secure access token (processing block 1260).

Thus, a system and method for providing a secure data container for an ambient intelligent environment are disclosed.

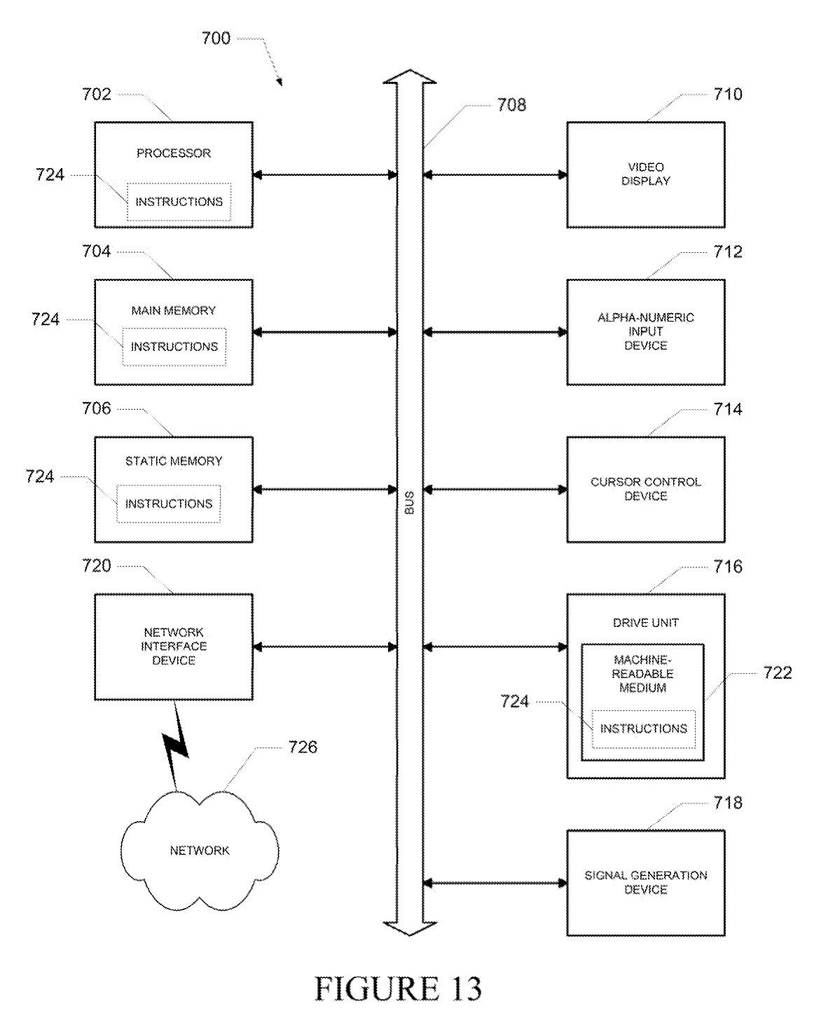

FIG. 13 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
collecting a set of information from a first digital network information endpoint associated with a vehicle;
associating, by use of a data processor, a persistent digital identifier with the collected information, the persistent digital identifier being derived from information associated with the vehicle;
enabling a user to specify a shared data set from the collected information;
enabling the user to specify a set of sharing controls corresponding to the shared data set;
combining information identifying the shared data set and the sharing controls in a secure container; and
enabling a second digital network information endpoint access the shared data set via the secure container upon presentation of a valid secure access token.

2. The method as claimed in claim 1 wherein the collected information is normalized, homogenized, and aggregated to form a unified data set associated with the persistent digital identifier.

3. The method as claimed in claim 1 wherein the collected information is stored in a network cloud.

4. The method as claimed in claim 1 wherein the persistent digital identifier is derived from the vehicle identification number (VIN) associated with the vehicle.

5. The method as claimed in claim 1 wherein the shared data set includes a current vehicle status, a current vehicle location, a driver profile, a driver calendar, and driver contact information.

6. The method as claimed in claim 1 including enabling the user to select a personalization template used to configure a presentation of the shared data set to the second digital network information endpoint.

7. The method a claimed in claim 1 wherein the sharing controls include access, privacy, expiry, synchronization, and usage controls.

8. The method as claimed in claim 1 including generating the secure access token with access control information.

9. The method as claimed in claim 1 including automatically pushing the shared data to the second digital network information endpoint based on a pre-configured trigger.

10. A system comprising:
one or more data processors; and
a vehicle-based Distributed Shared Data Object system, executable by the one or more data processors, to:
collect a set of information from a first digital network information endpoint associated with a vehicle;
associate a persistent digital identifier with the collected information, the persistent digital identifier being derived from information associated with the vehicle;
enable a user to specify a shared data set from the collected information;
enable the user to specify a set of sharing controls corresponding to the shared data set;
combine information identifying the shared data set and the sharing controls in a secure container; and
enable a second digital network information endpoint to access the shared data set via the secure container upon presentation of a valid secure access token.

11. The system as claimed in claim 10 wherein the collected information is normalized, homogenized, and aggregated to form a unified data set associated with the persistent digital identifier.

12. The system as claimed in claim 10 wherein the collected information is stored in a network cloud.

13. The system as claimed in claim 10 wherein the persistent digital identifier is derived from the vehicle identification number (VIN) associated with the vehicle.

14. The system as claimed in claim 10 wherein the shared data set includes a current vehicle status, a current vehicle location, a driver profile, a driver calendar, and driver contact information.

15. The system as claimed in claim 10 being further configured to enable the user to select a personalization template used to configure a presentation of the shared data sot to the second digital network information endpoint.

16. The system as claimed in claim 10 wherein the sharing controls include access, privacy, expiry, synchronization, and usage controls.

17. The system as claimed in claim 10 being further configured to generate the secure access token with access control information.

18. The system as claimed in claim 10 being further configured to automatically push the shared data to the second digital network information endpoint based on a pre-configured trigger.

19. A non-transitory machine-useable storage medium embodying instructions which, when executed by as machine, cause the machine to:
collect a set of information from a first digital network information endpoint associated with a vehicle;
associate a persistent digital identifier with the collected information, the persistent digital identifier being derived from information associated with the vehicle;
enable a user to specify a shared data set from the collected information;
enable the user to specify a set of sharing controls corresponding to the shared data set;
combine information identifying the shared data set and the sharing controls in a secure container; and
enable a second digital network information endpoint to access the shared data set via the secure container upon presentation of a valid secure access token.

20. The machine-useable storage medium as claimed in claim 19 wherein the persistent digital identifier is derived from the vehicle identification number (VIN) associated with the vehicle.
